(19) United States
(12) Patent Application Publication
(10) Pub. No.: US 2006/0096082 A1
(43) Pub. Date: May 11, 2006

(54) Flat plate electrochemical cell head space insulator

(76) Inventors: Paul B. Aamodt, Howard Lake, MN (US); Karl E. Hokanson, Coon Rapids, MN (US); Douglas J. Morelli, Forest Lake, MN (US); Kimberly A. Chaffin, Plymouth, MN (US)

Correspondence Address: MEDTRONIC, INC., 710 MEDTRONIC PARK, MINNEAPOLIS, MN, 55432-9924, US

(21) Appl. No.: 11/261,979

(22) Filed: Oct. 28, 2005

Related U.S. Application Data
(60) Provisional application No. 60/623,326, filed on Oct. 29, 2004.

(51) Int. Cl. H01M 10/04; H01M 2/16

(52) U.S. Cl. 29/623.4; 429/246

(57) ABSTRACT

A method of forming a head space insulator for an electrochemical cell is presented. A polymer is selected. The polymer has a melting point lower than the melting point of separator material. The polymer is heated to place the polymer into a liquid state. The liquid polymer is introduced over one or more tabs associated with one or more electrode plates.

### INCORPORATION BY REFERENCE

This non-provisional U.S. patent application hereby claims the benefit of U.S. provisional patent application Ser. No. 60/623,326, filed Oct. 29, 2004, entitled “Flat Plate Electrochemical Cell for an Implantable Medical Device”, the contents of which are incorporated by reference herein.

### FIELD OF THE INVENTION

The present invention relates to an electrochemical cell and, more particularly, to a head space insulator in an electrochemical cell.

### BACKGROUND

Implantable medical devices (IMDs) detect and treat a variety of medical conditions in patients. Exemplary IMDs include implantable pulse generators (IPGs) or implantable cardioverter-defibrillators (ICDs) that deliver electrical stimulation to tissue of a patient. IMDs typically include, inter alia, a control module, a capacitor, and a battery that are housed in a hermetically sealed container. When therapy is required by a patient, the control module signals the battery to charge the capacitor, which in turn discharges electrical stimuli to tissue of a patient.

The capacitor includes a case, an electrode stack, and a liner that mechanically immobilizes the electrode stack within the housing. The electrode stack is a repeated series of an anode plate, a cathode plate, and a separator therebetween. A single tab extends from each anode plate and cathode plate. A set of tabs extending from the anode plates are welded to form the anode whereas tabs from the cathode plates are welded together to form the cathode. To prevent the set of tabs from the anode or cathode from contacting the inside of a metallic housing and creating a short circuit, a premanufactured head space insulator is secured over the set of tabs. While capacitors continue to decrease in size, conventional head space insulators are generally more difficult to fit over each set of tabs. Additionally, some premanufactured headspace insulators are difficult to properly seat over a set of tabs. It is therefore desirable to develop a headspace insulator that overcomes these limitations.

### BRIEF DESCRIPTION OF THE DRAWINGS

FIG. 1 is a top perspective view of an exemplary electrochemical cell;

FIG. 2A a top perspective view of a set of tabs for an electrode stack of the electrochemical cell depicted in FIG. 1;

FIG. 2B an angled top perspective view of a set of tabs for an electrode stack of the electrochemical cell depicted in FIG. 1;

FIG. 3 is a top perspective view of a set of tabs and head space insulator for an electrode stack of the electrochemical cell; and

FIG. 4 is a flow diagram to form a head space insulator.

### DETAILED DESCRIPTION

The present invention is directed to a conformable head space insulator for a flat plate electrochemical cell (e.g. capacitor). The conformable head space insulator is created from a liquid or molten polymer introduced over one or more tabs that extend from electrode plates (e.g. anode plates or cathode plates). The polymer has a melting point lower than the melting point of separator material so that the temperature emanating from the polymer does not detrimentally affect the separator material.

The conformable head space insulator allows a technician to easily determine that the tab or tabs are adequately covered since the liquid polymer conforms to the shape of the tabs to be insulated. Reduction in assembly cost of the electrochemical cell is also realized by creating a conformable head space insulator after the electrode stack is fabricated. The headspace insulator may be applied to electrode stacks in capacitors or batteries (e.g., low, medium, and high current rate batteries).

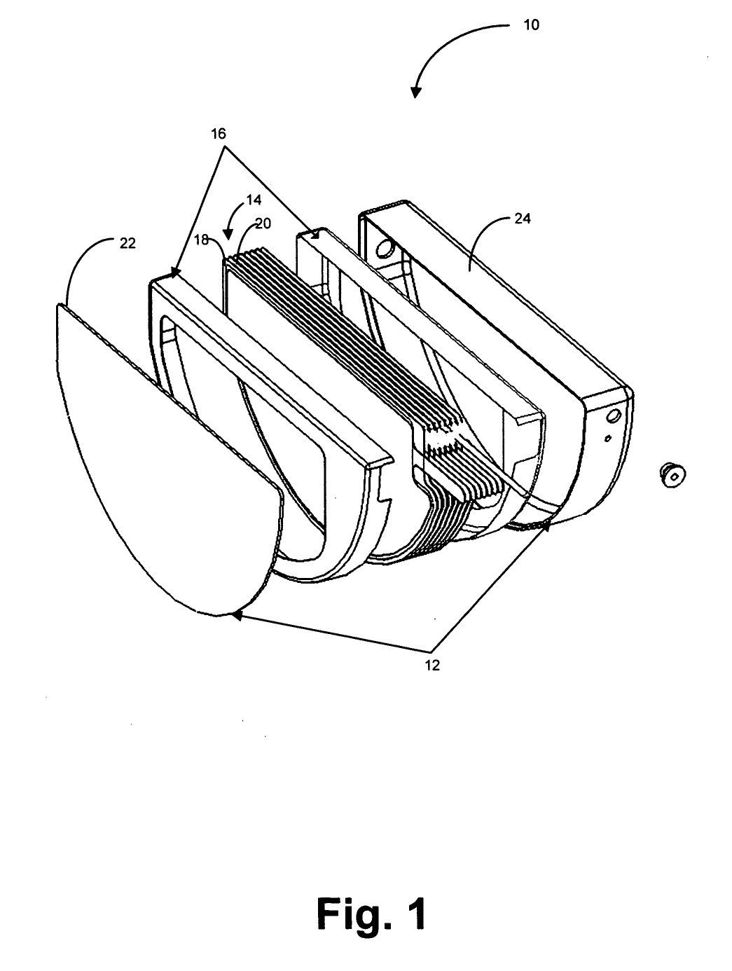

FIG. 1 depicts an exemplary electrochemical cell 10 (e.g. capacitor) for an implantable medical device (IMD). Electrochemical cell 10 includes a housing 12, an electrode stack 14, and a liner 16. Housing 12 is formed of a first portion 22 welded to a second portion 24. Liner 16 surrounds electrode stack 14 to prevent direct contact between electrode stack 14 and housing 12. A detailed example of such a configuration may be seen with respect to U.S. Pat. No. 6,459,566B1 issued to Casby et al. and U.S. Patent Publication No. 2003/0199941A1, and assigned to the assignee of the present invention, the disclosure of which is incorporated by reference, in relevant parts.

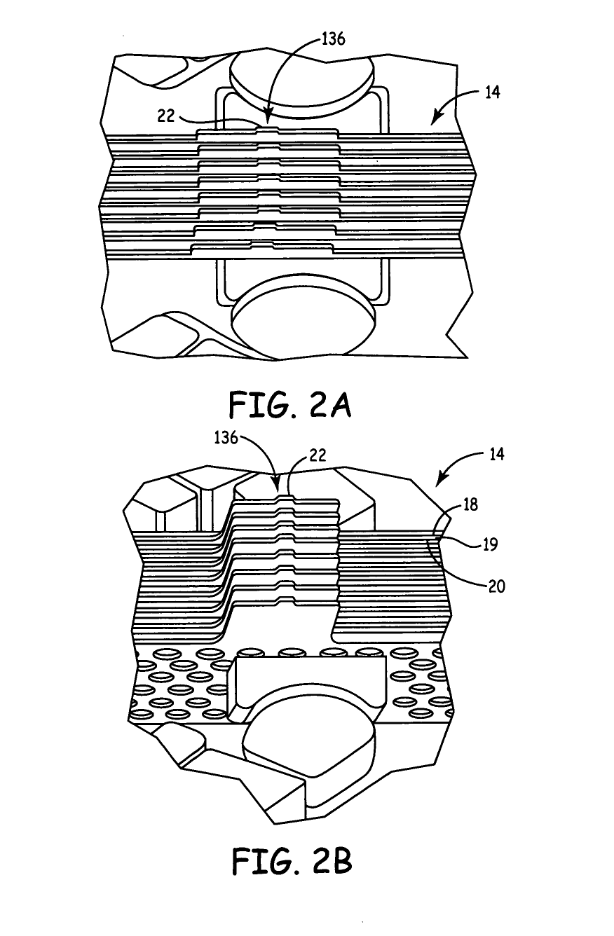

Referring to FIGS. 2A and 2B, electrode stack 14 is a repeated series of an anode plate 18, a cathode plate 20, and a separator 19 therebetween. A single tab 22 extends from each anode plate 18. A set of tabs 136, from a set of anode plates 18, are connected through one or more welds. A similar configuration applies to tabs of cathode plates 20.

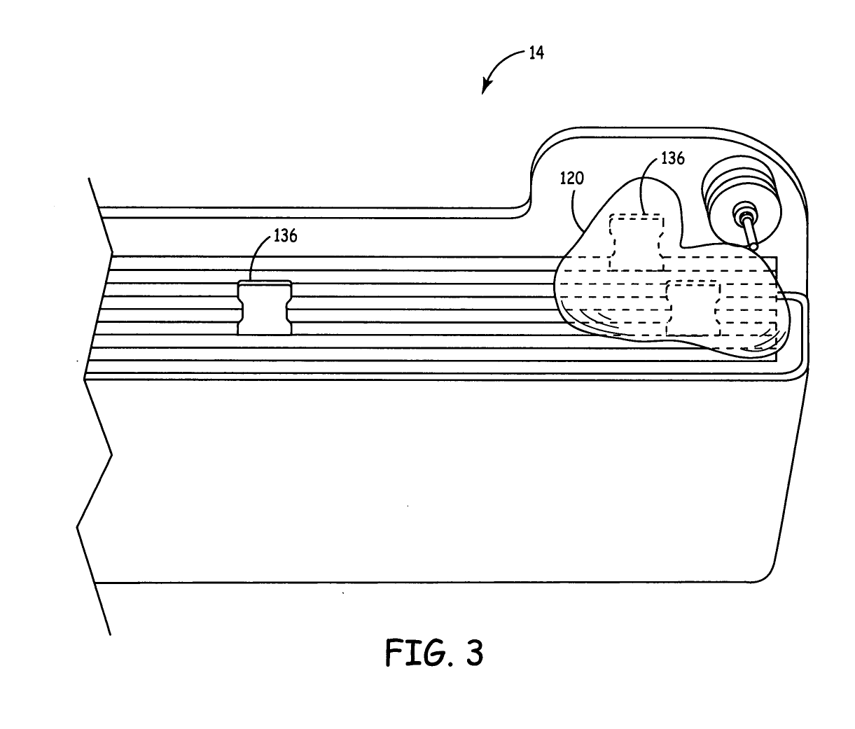

To create a conformable head space insulator 120, depicted in FIG. 3, a polymer (e.g. polyethylene) is selected. One of the factors considered in selecting a polymer is its melting point. The melting point of the polymer should be lower than the melting point of the separator material. Therefore, the polymer may be heated and applied in liquid form and not detrimentally affect the separator material.

Another factor considered in selection of the polymer is compatibility with the electrolyte. A compatible polymer (e.g. polyethylene etc.) does not chemically or physically react with electrolytes of electrochemical cell 10. An exemplary polymer includes ExxonMobil Exact 0201 commercially available from ExxonMobil located in Dallas, Tex.

The selected polymer is in a solid form (e.g. beads) and is heated in a heat gun commercially available from Gluegun Machinery Corporation. Typically, the polymer is heated to a temperature of about 100° C. or slightly above 100° C. Heat applied to the polymer causes the polymer to transition from a solid state to a liquid or molten state. In this state, the polymer is introduced to a tab 22 or a set of tabs 136 from the tip of the hot gun. In one embodiment, the head space area is overmolded with the polymer. Set of tabs 136 may include a large number of tabs (e.g. 10 or more tabs), which is difficult to accomplish with preformed head space insulators. The polymer transitions from the liquid state back to a solid state after the polymer is cooled at room temperature. Conformable head space insulator 120 provides strain relief for set of tabs 136 and protects electrode stack 14 against weld splatter or thermal damage during welding.

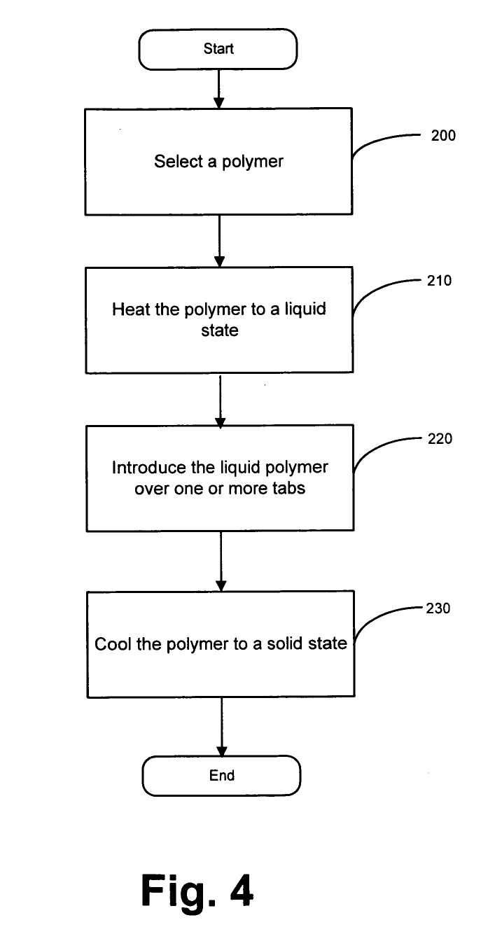

FIG. 4 is a flow diagram to create a conformable a head space insulator. At block 200, a polymer is selected. The polymer has a melting point (e.g. about 100° C.) lower than the melting point (e.g. 130° C.) of separator material. At block 210, the polymer is heated to place the polymer into a liquid state. At block 220, the liquid polymer is introduced over one or more tabs associated with one or more electrode plates (e.g. anode plate, cathode plate). At block 230, the polymer cools to a solid state thereby creating a conformable head space insulator.

It will be appreciated the present teachings can take many forms and embodiments. The true essence and spirit of these present teachings are defined in the appended claims, and it is not intended the embodiment of the present teachings presented herein should limit the scope thereof.

What is claimed is:

1. A method of forming a head space insulator for an electrochemical cell comprising:
selecting a polymer;
heating the polymer to a liquid state;
introducing the polymer over at least one tab coupled to an electrode plate; and
cooling the polymer to a solid state to form a head space insulator.

2. The method of claim 1, wherein the polymer has a melting point less than a melting point of a separator material.

3. The method of claim 1, wherein the at least one tab is overmolded.

4. The method of claim 1, wherein the polymer being introduced over the at least one tab occurs after assembly of an electrode stack.

5. A method of forming a head space insulator for an electrochemical cell comprising:
providing a first anode plate including a first anode tab extending therefrom;
coupling a first separator to the first anode plate;
coupling a first cathode plate to the first separator, the first cathode plate including a first cathode tab extending therefrom;
coupling a second separator to the first cathode plate;
coupling a second anode plate to the second separator, the second anode plate includes a second anode tab;
coupling a third separator to the second anode plate;
coupling a second cathode plate to the third separator, the second cathode plate including a second cathode tab extending therefrom;
coupling the first and second anode tabs;
introducing a liquid state polymer over the first and second anode tabs to form an anode tab insulator;
coupling the first and second cathode tabs; and
introducing additional liquid state polymer over the first and second cathode tabs to form cathode tab insulator.

6. The method of claim 5, further comprising:
conforming the anode tab insulator to adequately cover the first and the second anode tabs.

7. The method of claim 5, further comprising:
conforming the cathode tab insulator to adequately cover the first and the second cathode tabs.

8. The method of claim 6, further comprising:
cooling the anode tab insulator.

9. The method of claim 7, further comprising:
cooling the cathode tab insulator.
